(19) United States
(12) Patent Application Publication
(10) Pub. No.: US 2008/0278113 A1
(43) Pub. Date: Nov. 13, 2008

(54) Structure for Linking Battery Charger And Storage Unit

(76) Inventor: Eagle Fan, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/747,238

(22) Filed: May 11, 2007

(51) Int. Cl. H02J 7/00

(52) U.S. Cl. 320/113

(57) ABSTRACT

A structure for linking battery charger and storage unit device during recharging is provided. The battery charger is for recharging mobile phones and the storage unit is a leather bag, container, and so on. The linking structure includes an engaging element and a linking element. The engaging element is on the surface of the linking structure to engage tot eh surface of the battery charger. The linking structure is a reusable attaching structure that can be attached to the storage unit. The linking element has the same structure as the linking element on the storage unit so that the present invention will hang the storage unit for storing the mobile phone below the battery charger during recharging.

### FIELD OF THE INVENTION

The present invention generally relates to a structure for linking battery charger and storage unit, and more specifically to a structure for linking the battery charger and a storage unit for protecting the recharged mobile phone during the recharging process to avoid damages.

### BACKGROUND OF THE INVENTION

The conventional power socket in a common household is usually located on a vertical wall with a few exceptions that are strategically located on a horizontal surface, such as, table top or floor, in accordance with the interior design. As the portable devices, such as mobile phone, usually use battery, it is necessary for the users to recharge the battery for portable devices. Therefore, it is not uncommon to see that a battery charger is plugged into a power socket with an electronic device dangling without support or laying on the floor near the wall with tangled wires. Not only the recharged electronic device in this arrangement is prone to being kicked and damaged, it also poses potential danger to the user as the user may trip over the tangled wires or the electronic device and fall. Some users may place a stool or a chair close to the power socket, and put the recharged electronic device on the tool or the chair to prevent the accident. However, for the users in an unfamiliar environment, such as travelers, it may not always be practical to find a stool for that purpose. Therefore, it is imperative to provide a convenient structure to overcome the problem in the above scenario and improve the safety for the recharging process.

### SUMMARY OF THE INVENTION

The primary object of the present invention is to provide a structure for linking the battery charger and the storage unit for recharged electronic device during recharging. There are storage units for portable devices, such as mobile phones and battery charger, currently available, such as leather sheath, or bags. The present invention provides a linking structure to engage the battery charger and the storage unit so that the storage unit can be hanged below the battery charger during the recharging. The storage unit can accommodate the electronic device as well as the wires of the battery charger. As the wires and the electronic device devices are all placed inside the storage unit, instead of laying on the floor, the potential danger of tripping over or scratching the electronic device can be prevented.

Another object of the present invention is to provide a structure for linking battery charger and storage unit applicable to various types and locations of power socket designs. Most power sockets are vertical two-hole or three-hole, with a few exceptions that are horizontal two-hole or three-hole. The linking structure of the present invention can be applied in different orientations to fit the direction of the socket.

Yet another object of the present invention is to provide a simple linking structure that is applicable to various specifications of battery chargers and storage units. By utilizing a flat surface of a battery charger, the present invention can be easily attached to a battery charger without interfering with the recharging process. The storage unit can be the storage unit that comes with the mobile phone or the battery charger. In addition, the simple structure and the ease of manufacturing of the present invention also provide market competitive advantages.

To achieve the above objects, the present invention provides a structure for linking battery charger and storage unit for recharged electronic device during recharging, including a linking element and an engaging element. The engaging element is located on the surface of the inking structure for engaging the linking structure with the battery charger. The linking element is a set of re-attachable linkage, which is the same as the linkage on the storage unit. Therefore, when the battery charger is plugged in the socket for recharging, the linking structure of the present invention can hang the storage unit below the battery charger for housing the mobile phone.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional view of the present invention;

FIG. 1A shows a three-dimensional view of the linking structure of the present invention from a different angle;

FIG. 1B shows another embodiment of the engaging element of the present invention;

FIG. 2 shows a side view of the present invention when in use;

FIG. 3 shows a schematic view of a second embodiment of the present invention;

FIG. 4 shows a schematic view of a third embodiment of the present invention;

FIG. 5 shows a schematic view of a fourth embodiment of the present invention;

FIG. 6 shows a schematic view of the actual application of the embodiment of FIG. 5; and

FIG. 7 shows a schematic view of another actual application of the embodiment of FIG. 5.

### DETAILED DESCRIPTION OF THE PREFERRED EMBODIMENTS

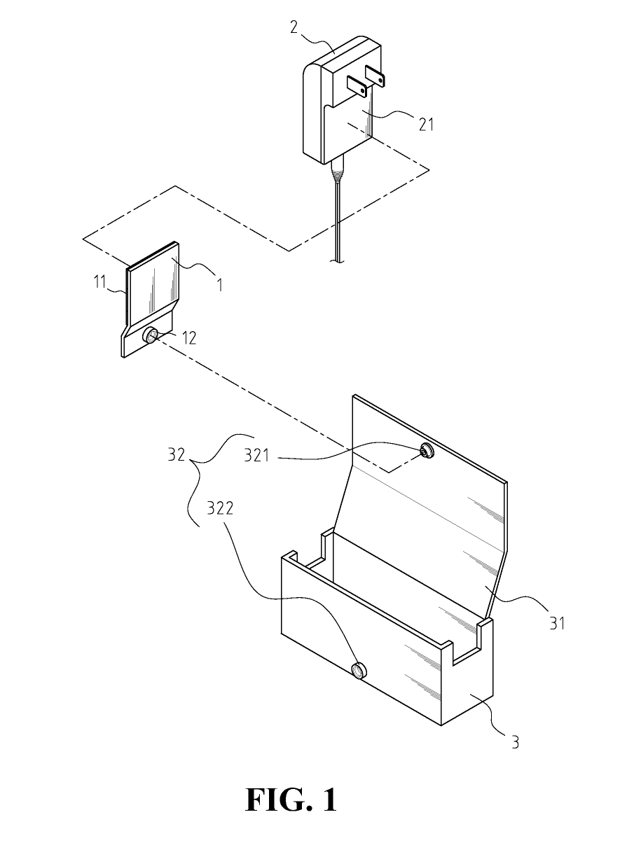

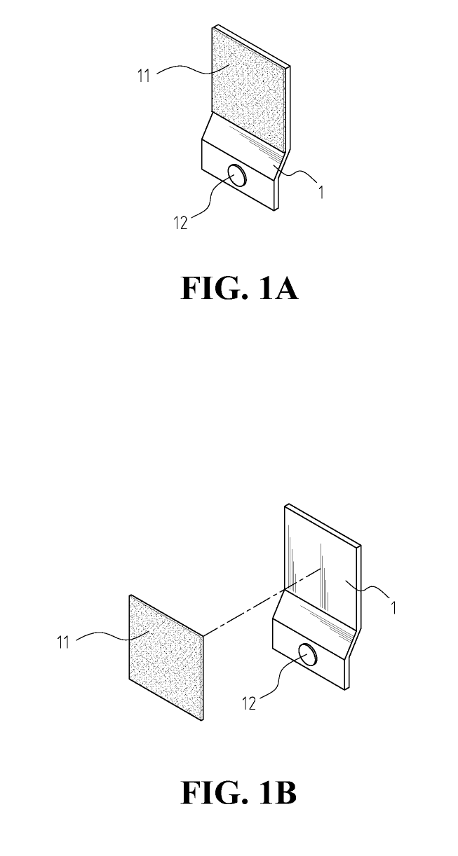

FIG. 1 shows a schematic view of the present invention. A linking structure 1 is used for linking a battery charger 2 and a storage unit 3. Battery charger 2 and storage unit 3 can be both readily available items. In the embodiment of the present invention, storage unit 3 is a rectangular-shaped leather bag. Storage unit 3 further includes a top cover 31 and a press button set 32. Press button set 32 includes a stud 321 and a socket 322. In the present embodiment, stud 321 is located on top cover 31, and socket 322 is located on the vertical surface of the leather bag corresponding to stub 321 so that stud 321 and socket 322 can be pressed to enclose the storage unit. Linking structure 1 of the present invention includes an engaging element 11 and a linking element 12. Engaging element 11 is located on the surface of linking structure 1. As shown in FIG. 1A, engaging element 11 is a glue, and in FIG. 1B, engaging element 11 is double-sided duck tape, which can be attached to the surface of linking structure 1. Therefore, engaging element 11 can be a material with stickiness. Engaging element 11 engages linking structure 1 to the flat surface 21 of battery charger 2 so that both can be tightly engaged. Linking element 12 is for temporarily attaching to the leather bag of storage unit 3. The way that linking element 12 uses to link is using the press button set 32 of storage unit 3. In the present embodiment, linking element 12 and socket 322 of press button set 32 are identical. Therefore, linking element 12 can be fixated with stud 321 on top cover 31 of storage unit 3 to form temporary linkage.

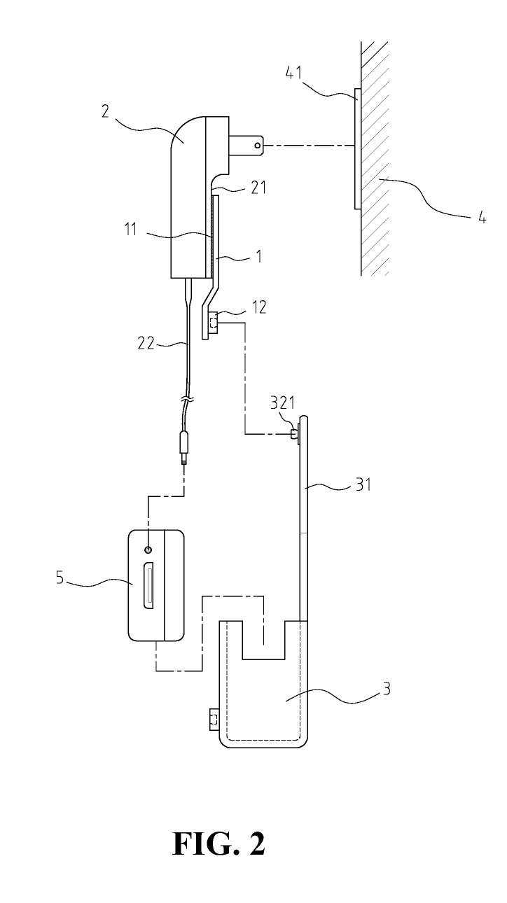

FIG. 2 shows the actual application of the present invention. As shown in FIG. 2, when the first time linking structure 1 is applied, the present invention uses engaging element 11 on linking structure 1 to engage flat surface 21 of battery charger 2. Once engaged, the present invention will not be disengaged from battery charger 2. When battery charger 2 is plugged into power socket 41 on wall 4, linking element 12 of linking structure 1 is used to link stud 321 on top cover 31 of storage unit 3 so that battery charger 2, linking structure 1 and storage unit 3 are all connected. When battery charger 2 uses wire 22 to charge mobile phone 5, mobile phone 5 can be placed inside storage unit 3, which is hanged below battery charger 2 by linking structure 2 to protect mobile phone 5 from scratch or damage. When the recharging is complete, linking element 12 of linking structure 1 can be detached from stud 321 on top cover 31 of storage unit 3 so that storage unit 3 can still accommodate mobile phone for portability.

In the above embodiment, storage unit 3 is the leather bag for the mobile phone. But the present invention is not limited to the leather bag for the mobile phone. Storage unit 3 can also be a leather bag for battery charger, and the leather bag for the battery charger can be buckled to the linking element 12 of linking structure 1 for temporarily accommodating the mobile phone during recharging. Therefore, storage unit 3 can be any container, leather bag, or small package that can accommodate an item.

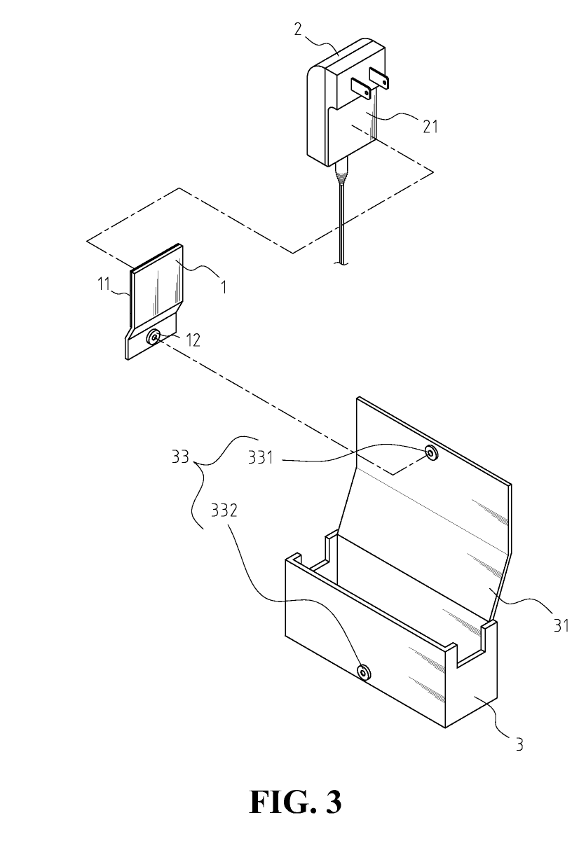

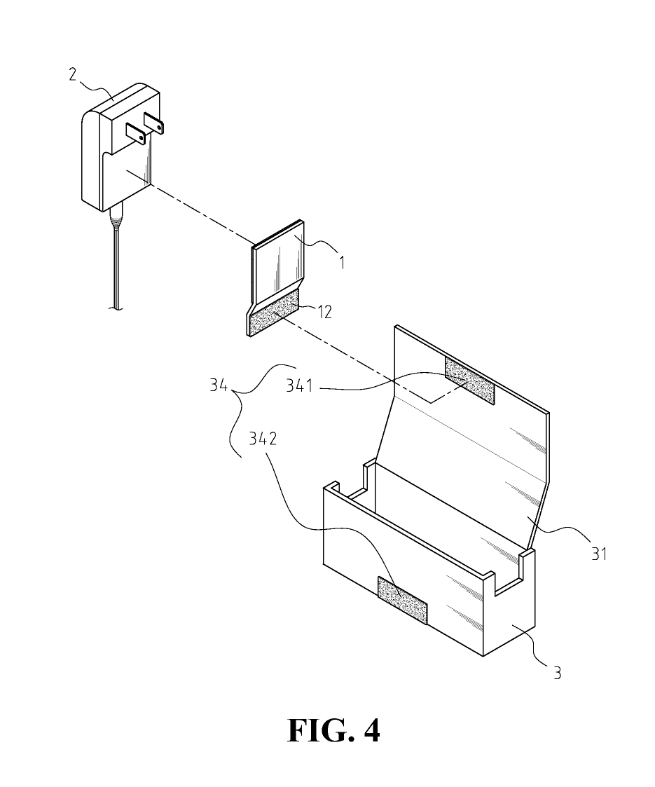

In the previous embodiment, storage unit 3 uses press button set 32 to engage top cover 31 and storage unit 3, but the present invention is not limited to this. As shown in FIG. 3, storage unit 3 can also use a magnetic button set 33, including a stud 331 and a socket 332, for engaging structure. Similarly, corresponding linking element 12 of linking structure 1 is also of the same structure as the magnetic button set. FIG. 4 shows the third embodiment of the present invention. As shown in FIG. 4, storage unit 3 uses a touch fastener set 34, including fastener 341, and touch faster 342, for engaging structure, and corresponding linking element 12 of linking structure 1 is also of the same structure as the touch fastener set. It is obvious that linking element 12 of linking structure 1 can be made to match the structure used in storage unit 3 as long as the structure for linking element 12 is a reusable engaging structure. Therefore, the present invention can be applied to various types of battery charger regardless of the location or the placement of the power socket.

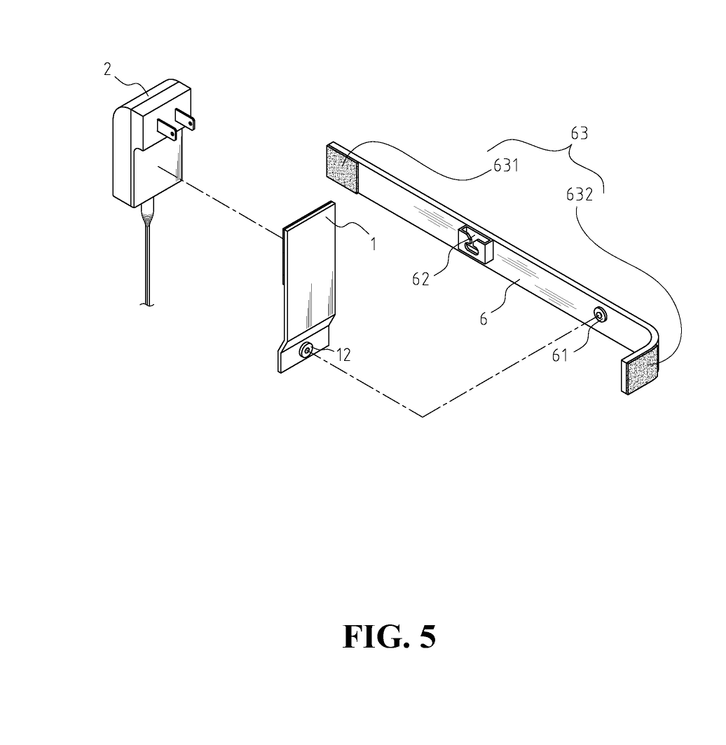

FIG. 5 shows a fourth embodiment of the present invention. As shown in FIG. 5, an additional accessory is designed to work with linking structure 1 so as to match the leather bags for mobile phones of different specifications. Accessory 6 is a long belt, further including a buckle 61, a concave groove 62 and a touch fastener set 63. Buckle 61 is to match linking element 12 of linking structure 1. In this embodiment, linking element 12 is a socket, and buckle 61 is a stud. The concave groove is on the surface of accessory 6 to match the protruding part on some leather bags, which will be described later. Touch fastener set 63 includes two touch fasteners 631, 632 of matching shape. Touch fasteners 631, 632 are located on the opposite side of the two ends of accessory 6 so that accessory 6 can form a ring when touch fasteners 631, 632 are fastened together.

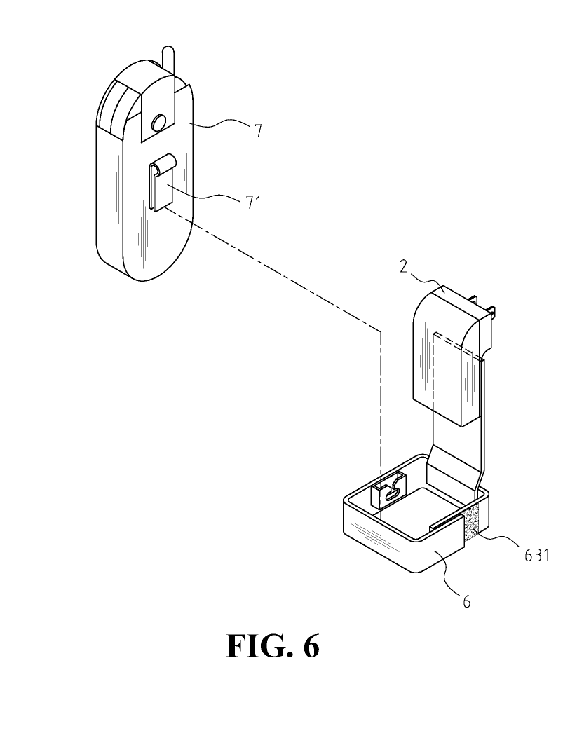

FIG. 6 shows a fifth embodiment of the present invention. As shown in FIG. 6, leather bag 7 for mobile phone only includes a back clip 71 on the back of leather bag 7. Accessory 6 uses buckle 61 to engage linking element 12 of linking structure 1, and then accessory 6 forms a ring by fastening touch fasteners 631, 632 on both ends. Leather bag 7 for mobile phone can be inserted inside the ring formed by accessory 6, and back clip 71 is used to clip onto accessory 6 so that the mobile phone is attached to accessory 6. To provide further holding, accessory 6 can form a ring surrounding the mobile phone, and touch fasteners 631, 632 are fastened surrounding the mobile phone. Therefore, the mobile phone can hang below the battery charger during recharging.

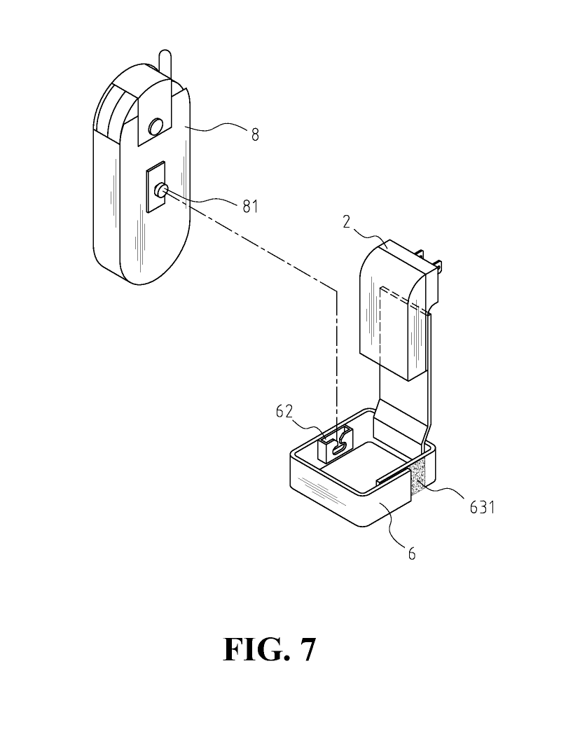

FIG. 7 shows a schematic view of another actual application of the embodiment of FIG. 5. In this embodiment, leather bag 8 for mobile phone includes a protruding part 81 on the back. Protruding part 8 has the shape of a door knob, i.e., the tip of protruding part 81 is bigger than the end attaching to leather bag 8. Accessory 6 can form a ring as aforementioned. Protruding part 81 of leather bag 8 can be inserted into concave groove 62 of accessory 6 so as to fixate leather bag 8 to accessory 6. Therefore, the mobile phone will hang below battery charger 2 during recharging.

In summary, the engaging element of the present invention is to engage the battery chargers of various specifications, and the linking element of the present invention is to temporarily link a storage unit for accommodating the mobile phone during recharging to provide protection to the mobile phone. Alternatively, an accessory can be added to hang the leather bags for mobile phone below the battery charger during recharging. The present invention is simple in structure and easy to manufacture, and therefore competitive in market.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A linking structure for linking a battery charger and a storage unit during recharging, comprising:
an engaging element, located on s surface of said linking structure, for engaging said linking structure to a surface of said battery charger; and
a linking element, located on said linking structure, being a reusable attaching structure, said attaching structure able to attach to a structure on said storage unit.

2. The linking structure as claimed in claim 1, wherein said storage unit is a container for accommodating an object, said storage unit at least comprises an top cover, and a press button set, said press button set further comprises a stud and a socket, said stud and said socket are located on said storage unit and said top cover, and said linking element of said linking structure has the same structure as said press button set so that said top cover can be linked with said linking element.

3. The linking structure as claimed in claim 2, wherein said storage unit comprises a magnetic button set, and said linking element of said linking structure has the same structure as said magnetic button set.

4. The linking structure as claimed in claim 2, wherein said storage unit comprises a touch fastener set, and said linking element of said linking structure has the same structure as said touch fastener set.

5. The linking structure as claimed in claim 1, wherein said engaging element is a material with stickiness.

6. The linking structure as claimed in claim 1, wherein said linking structure further comprises an accessory, said accessory is a long belt further comprises a buckle and a touch fastener set, said buckle is located on said accessory with a structure matching said linking element of said linking structure, said touch fastener set comprises two touch fasteners of matching shape, said two touch fasteners are located on opposite surfaces of two ends, and said accessory forms a ring by fastening two said touch fasteners.

7. The linking structure as claimed in claim 6, wherein said accessory further comprises a concave groove, said concave groove is protruding and located on surface of said accessory.
